(19) United States
(12) Patent Application Publication
(10) Pub. No.: US 2023/0329240 A1
(43) Pub. Date: Oct. 19, 2023

(54) HYPOCHLOROUS ACID COMPOSITION

(71) Applicant: White Factor International Limited, Tortola (VG)

(72) Inventors: Han-Po Wang, Taipei City (TW); Hsiang-En Tseng, New Taipei City (TW)

(21) Appl. No.: 18/211,831

(22) Filed: Jun. 20, 2023

Related U.S. Application Data
(63) Continuation-in-part of application No. 17/230,125, filed on Apr. 14, 2021, now abandoned.

(30) Foreign Application Priority Data
Mar. 11, 2021 (TW) 110108653

(51) Int. Cl. A01N 59/00; A01N 25/02; A01P 1/00

(52) U.S. Cl. CPC A01N 59/00; A01N 25/02; A01P 1/00

(57) ABSTRACT

The present application discloses a hypochlorous acid composition and applications thereof wherein the hypochlorous acid composition comprises fluorosilicate, hypochlorous acid, and hypochlorite. The viscosity of the hypochlorous acid composition can be changed by exerting different pressures, wherein a low-viscosity fluid can be transformed into a variety of fluids with different high viscosities through pressure. Also, the high-viscosity hypochlorous acid fluid can also be formed by spraying, so that the high-viscosity hypochlorous acid fluid can be evenly coated on the surface of an object without a medium. The risks of infection and contamination when using the hypochlorous acid fluid can be mitigated, while spreading the application of hypochlorous acid in sterilization as well as cleaning and washing.

### RELATED APPLICATIONS

This application is a continuation-in-part application of U.S. application Ser. No. 17/230,125 filed on Apr. 14, 2021, and claims priority to Taiwan application Ser. No. 110108653 filed on Mar. 11, 2021, the disclosure of which is hereby incorporated by reference herein in its entirety.

### FIELD OF THE INVENTION

The present application discloses a hypochlorous acid composition and applications thereof. More particularly, the viscosity of the hypochlorous acid composition may be changed by exerting different pressures. Pressurized (e.g. sprayed) hypochlorous acid composition can be transformed to high-viscosity hypochlorous acid fluids which are evenly coated on the surface of an object for a long period of time without a medium.

### DESCRIPTION OF THE PRIOR ART

The hypochlorous acid as an effective ingredient for the anti-microbial function is used to kill microbes such as viruses, bacteria, and fungi in a variety of environments but criticized for some drawbacks, for example, sterilization is adversely affected by a pH value which is optimal for disinfection between 4 and 7, difficult preservation, i.e., degradation of the hypochlorous acid contacting with oxygen, sunlight or heat, and poor compatibility, i.e., the hypochlorous acid is difficultly synthesized with other substances for the production of a new formulation. Accordingly, the application of the hypochlorous acid is limited.

There is a need for the hypochlorous acid products with different viscosities, because of different purposes of use. For example, for the needs to use hypochlorous acid as a disinfectant for a dry wash of hand, it is a good option to adopt a hypochlorous acid product in gel form, because a high-viscosity gel has better adhesion. In the case of the hypochlorous acid product on the market at present, the viscosity of the hypochlorous acid product as contained in a bottle is the same as that of the hypochlorous acid product as applied to the body. For example, in the case of the hypochlorous acid product in gel form, the hypochlorous acid product that is in gel form as contained in a bottle is also in gel form as it is extruded out and applied to the body. In the case of the hypochlorous acid product in liquid form, the hypochlorous acid product that is in liquid form as contained in a bottle is also in liquid form as it is sprayed out and applied to the body. Hypochlorous acid gels squeezed out from a tube by a user troublesome and spread unevenly should be applied on a surface to be disinfected by hands or another medium and give rise to contact pollution easily. In addition, a sprayer may be jammed by a sticky hypochlorous acid gel product.

A hypochlorous acid product in liquid form can be conveniently portioned and packed and also will not block the outlet of a sprayer, but it is easy for it to drip and not easy for it to adhere to the surface of an object or skin when used. The hypochlorous acid products with different viscosities have their own merits or otherwise. The present inventors expect to propose a hypochlorous acid product that meets the above needs. A hypochlorous acid fluid composition that its viscosity can be changed is obtained through many times of experiment. This hypochlorous acid fluid composition is in a liquid state before pressurizing (e.g. spraying). Its viscosity will be changed, and it can even become a gel state, after a pressure is exerted. Its viscosity is directly proportional to the pressure exerted on it.

### SUMMARY OF THE INVENTION

A hypochlorous acid composition and applications thereof are explained hereinafter through test data in example comparisons and embodiments for clear understanding of technical features, content, advantages, and efficiency by patent examiners.

For clear descriptions of differences in example comparisons and embodiments of the present disclosure, the sterilization effect of a hypochlorous acid composition is indicated by free available chlorine (FAG) which denotes a concentration of chlorine in a hypochlorous acid composition.

For that matter, a person with general knowledge in the art is conscious of the fact that the higher content of FAC contributes to the better sterilization effect of a substance.

In the tests of the present disclosure, the content of FAC, which is represented by ppm (parts per million), in a hypochlorous acid composition stored for a long period of time is compared with the initial content of FAC in a hypochlorous acid composition and the ratio of both FACs is indicated as percentage (%).

A thermal ageing test in the present disclosure is aimed at checking stabilities of hypochlorous acid fluids made of different compositions and stored for a long period of time in a high-temperature environment through which an environment for long-term storage at room temperature is simulated.

In the thermal ageing test in the present disclosure, a determinant is carried in a glass bottle which is sealed by a PP (polypropylene) cap and stored in an oven for a 14-day test at 54° C. based on test parameters to simulate storage status at room-temperature for one year and check the stability of hypochlorous acid fluids.

The viscosity of hypochlorous acid fluids is measured by a viscosity meter (HVDV-II+ manufactured by Brookfield) equipped with a probe (LV1, RV1 or LV2) in the test. The viscosity meter is operated in a beaker in which an appropriate amount of test fluids are carried (test conditions: 1-100 rpm; room temperature) for measuring viscosities of different compositions or fluids.

### BRIEF DESCRIPTION OF THE DRAWINGS

FIG. 1 shows the viscosity form of the hypochlorous acid composition product of the present application before pressurizing (left side) and after pressurizing (right side).

FIG. 2 shows the viscosity change of the hypochlorous acid composition product of the present application under variety pressures.

### DETAILED DESCRIPTION OF THE INVENTION

### Embodiment 1: Method to Prepare a Hypochlorous Acid Composition

Reagents required:

| | | |
|---|---|---|
| Sodium magnesium fluorosilicate | 3 | wt % |
| HClO solution | 94.12 | wt % |
| 1M acid solution | 2.88 | wt % |

Steps to prepare a hypochlorous acid composition:
S101: Add sodium magnesium fluorosilicate into the HClO solution (25° C.) gradually for preparation of a precursor solution;
S102: Stir the precursor solution for at least 30 minutes until no powder or lump is observed;
S103: Check production of a translucent gelatinous liquid and add acid solution, wherein the acid solution is strong acid, comprising Chloric acid (HClO₃), Hydrobromic acid (HBr), Hydrochloric acid (HCl), Hydroiodic acid (HI), Nitric acid (HNO₃), Perchloric acid (HClO₄) or Sulfuric acid (H₂SO₄); wherein the acid solution is not phosphoric acid or hypochlorous acid.
S104: Stir the mixed solution until its viscosity ranges from 100 to 2000 cp and leave the solution to stand for a pH value stabilized.

A final hypochlorous acid composition includes ingredients shown as follows:

| | | |
|---|---|---|
| Sodium magnesium fluorosilicate | 3 | wt % |
| Hypochlorous acid | 0.02 | wt % |
| Water | 96.812 | wt % |

| | |
|---|---|
| Other | 0.168% |

In the above list, “other” refers to by-products derived from Step S101 to Step S104, for example, sodium chloride.

### Embodiment 2: Method to Prepare a Hypochlorous Acid Composition

Method to Prepare a Hypochlorous Acid Composition

Reagents required:

| | | |
|---|---|---|
| Sodium magnesium fluorosilicate | 2.0 | wt % |
| HClO solution | 96.56 | wt % |
| 1M sulfuric acid solution | 1.44 | wt % |

Steps to prepare a hypochlorous acid composition:
S101: Add sodium magnesium fluorosilicate into the HClO solution (25° C.) gradually for preparation of a precursor solution;
S102: Stir the precursor solution for at least 30 minutes until no powder or lump is observed;
S103: Check production of a translucent gelatinous liquid and add acid solution, wherein the acid solution is sulfuric acid (H₂SO₄);
S104: Stir the mixed solution until its viscosity ranges from 1 to 2000 cp and leave the solution to stand for a pH value stabilized.

A final hypochlorous acid composition includes ingredients shown as follows:

| | | |
|---|---|---|
| Water | 97.763 | wt % |
| Sodium Magnesium Fluorosilicate | 2 | wt % |
| Hypochlorous Acid | 0.015 | wt % |
| Sodium Sulfate | 0.204 | wt % |
| Sodium Chloride | 0.018 | wt % |

Above-mentioned sulfuric acid may be replaced with other strong acids, such as Chloric acid (HClO₃), Hydrobromic acid (HBr), Hydrochloric acid (HCl), Hydroiodic acid (HI), Nitric acid (HNO₃), or Perchloric acid (HClO₄), so that the mount of Sodium Sulfate in its corresponding by-product will be different, and the composition further include chlorate, bromide, chloride, iodide, nitrate, perchlorate, or sulfate, as illustrated in Table 1.

TABLE 1

| Strong Acids | By-product |
|---|---|
| Chloric acid: HClO₃ | Chlorate |
| Hydrobromic acid: HBr | Bromide |
| Hydrochloric acid: HCl | Chloride |
| Hydroiodic acid: HI | Iodide |
| Nitric acid: HNO₃ | Nitrate |
| Perchloric acid: HClO₄ | Perchlorate |
| Sulfuric acid: H₂SO₄ | Sulfate |

### Embodiment 3: Application of a Hypochlorous Acid Composition

The reagent is the hypochlorous acid composition prepared in Embodiment 1.

Steps for the application of the hypochlorous acid composition are shown as follows:
S201: Pressurize (spray) the hypochlorous acid composition prepared in Embodiment 1 from a pressurizer (sprayer);
S202: Hypochlorous acid fluids with the viscosity ranging from 6,400 to 17,000 cp form after the hypochlorous acid composition is pressurized (sprayed).

### Embodiment 4: Changes in Viscosity of Hypochlorous Acid Fluids Before and After Spraying

Stored as a liquid, the hypochlorous acid composition in the present disclosure (formula as Embodiment 1) is transformed to gelatinous substances and covers a surface to be disinfected for lower contamination and infection risks while sprayed from a nozzle without another medium. Accordingly, the change in viscosity of the hypochlorous acid composition before and after spraying should be checked. As shown in Table 2, the viscosity of prepared hypochlorous acid fluids which have been sprayed increases significantly and is 2.8 times higher than the original viscosity. Moreover, the hypochlorous acid composition stored as a liquid doesn't adhere to a vertical surface in the beginning but is sprayed and transformed to high-viscosity hypochlorous acid fluids which adhere to a vertical surface.

TABLE 2
Change in viscosity of a hypochlorous acid
composition before and after spraying

| Sample | Viscosity (cp) | Increase (%) |
|---|---|---|
| Before spraying | 2880 | |
| After spraying | 8040 | 279.1% |

### Embodiment 5: Changes in Viscosity of Hypochlorous Acid Fluids Prepared with Sodium Magnesium Fluorosilicates Having Specific Ingredient Proportions

As shown in Table 3, the viscosities of prepared hypochlorous acid fluids which have been pressurized increase significantly, for example, the viscosity of hypochlorous acid fluids prepared with 3.00 wt % sodium magnesium fluorosilicate is 9.3 times higher than the hypochlorous acid composition not sprayed.

TABLE 3
Change in viscosity of a hypochlorous acid composition
prepared with sodium magnesium fluorosilicate having a
specific ingredient proportion before and after spraying

| | Viscosity (cp) | | |
|---|---|---|---|
| | Before | After | Increase |
| Sample | spraying | spraying | (%) |
| 2.50 wt % sodium magnesium | 1664 | 11264 | 676.9 |
| fluorosilicate | | | |
| 3.00 wt % sodium magnesium | 1536 | 14336 | 933.3 |
| fluorosilicate | | | |

### Embodiment 6

Sample Preparation:
(1) The hypochlorous acid composition product of the present application (formula as Embodiment 2).

Assay:
(1) Before pressurizing (spraying): Apply the composition to the hands and spread to a petri dish without pressurizing (spraying).
(2) After pressurizing (spraying): Use the pressurizer (sprayer) to pressurize (spray) the composition.

Results:

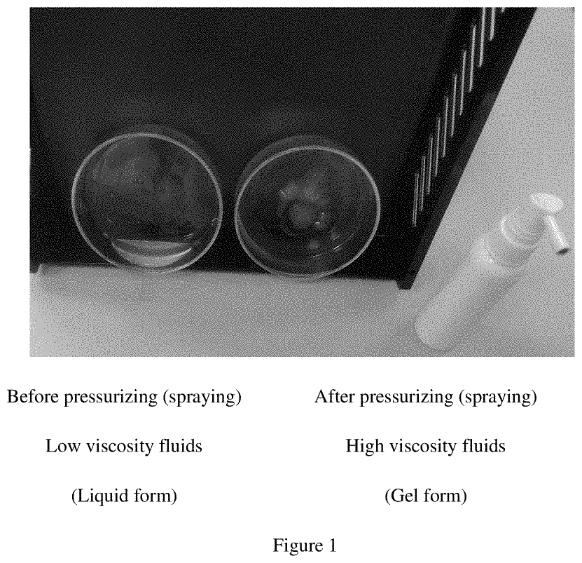

The hypochlorous acid composition product of the present application: The test results showed that “the hypochlorous acid composition of the present application stored as a liquid doesn't adhere to a vertical surface in the beginning but is pressurized and transformed to high-viscosity hypochlorous acid fluids which adhere to a vertical surface.” It can be seen from the figure above that the recited hypochlorous acid composition is stored in a bottle in a state of low viscosity. When the hypochlorous acid composition is applied to the hands and spread to a glass petri dish, it cannot attach to the glass petri dish on a vertical tabletop (left side of the FIG. 1). On the other hand, when the hypochlorous acid composition is pressurized from the bottle into a glass petri dish, it can attach to the glass petri dish on a vertical table top (right side of the FIG. 1).

### Embodiment 7: Changes in Viscosity of the Hypochlorous Acid Composition Under Different Pressures

Sample Preparation:
(1) The hypochlorous acid composition product of the present application (formula as Embodiment 2).

Results:

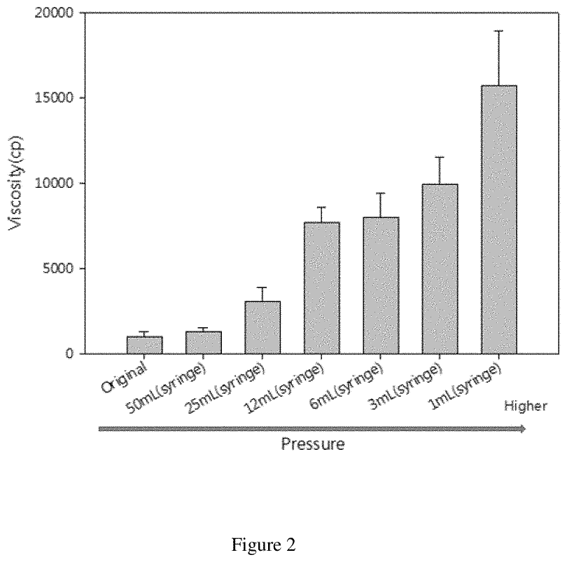

In this experiment, the approaches for generating different pressures are as follows. Under a certain force, the fluid enters a nozzle through the needle cylinder to generate pressure. In this embodiment, various pressures are exerted on the hypochlorous acid composition. In an experiment, a needle cylinder with a capacity of 1 to 50 ml is used. The smaller the capacity of a needle cylinder, the smaller the cross-sectional area of the outlet of the needle cylinder. When the same force is exerted, the smaller the cross-sectional area of the outlet, the greater the pressure generated at the outlet. As illustrated in FIG. 2, the results demonstrate that as the pressure undergone by the hypochlorous acid composition according to the present invention becomes higher and higher, its viscosity also increases. The viscosity of the hypochlorous acid composition is less than 1100 cp before a pressure is exerted, but the viscosity increases after a pressure is exerted. After a pressure is exerted, the viscosity of the hypochlorous acid composition increases with the increase of the pressure, and its viscosity can even exceeds 15,000 cp.

In the case of the hypochlorous acid composition according to the present invention, the hypochlorous acid compositions with different viscosities can be generated by configuring a nozzle with different pressures according to the needs in use.

### Embodiment 8: Comparisons of Stability for the Hypochlorous Acid Fluid Prepared from Sodium Magnesium Fluorosilicate with the Hypochlorous Acid Gel Prepared from Silicate

The stabilities of the sodium magnesium fluorosilicate, i.e., the raw material of hypochlorous acid fluids in the patent application, and silicate, i.e., the raw material of other hypochlorous acid gels commercially available, are compared.

Hypochlorous acid fluid is prepared with sodium magnesium fluorosilicate. Hypochlorous acid gel is prepared with silicate commercially available. the hypochlorous acid fluids and gel are carried in glass bottles sealed by PP caps for a 14-day thermal ageing test at 54° C., respectively. Then, the properties such as pH value and content of FAC of hypochlorous acid fluid and gel are checked and shown in Table 4. According to test results, compared with the hypochlorous acid gel prepared from silicate, the hypochlorous acid fluid prepared from sodium magnesium fluorosilicate has a better pH value and hypochlorous acid stability. Also, it is demonstrated that the hypochlorous acid gel prepared from silicate does not have the property that its viscosity can be changed by exerting different pressures.

TABLE 4
Ageing test for the hypochlorous acid fluid prepared from sodium magnesium
fluorosilicate and the hypochlorous acid gel prepared from silicate and their properties

| | Content of | | | | | | |
|---|---|---|---|---|---|---|---|
| | FAC (ppm) | | Preservation | pH | | Before | After |
| Sample | 0 | 14 days | of FAC (%) | 0 | 14 days | pressurizing | pressurizing |
| Hypochlorous acid fluid by | 170 | 117 | 68.8% | 5.72 | 6.6 | No adhesion | Adhesion to |
| Sodium magnesium fluorosilicate | | | | | | to arms | arms |
| (patent application) | | | | | | | |
| Hypochlorous acid gel by | 171 | 91 | 53.20% | 7.18 | 7.21 | Adhesion to | Adhesion to |
| Silicate (commercially available) | | | | | | arms | arms |

### Embodiment 9: Comparisons of Stability and Properties for the Hypochlorous Acid Fluid Prepared from a Strong Acid with the Hypochlorous Acid Gel Prepared from Phosphoric Acid

The stability and properties of the hypochlorous acid fluid prepared from sodium magnesium fluorosilicate and a strong acid are compared with the stability and properties of the hypochlorous acid gel prepared from sodium magnesium fluorosilicate and phosphoric acid. Hypochlorous acid fluid and gel are carried in glass bottles sealed by PP caps for a 14-day thermal ageing test at 54° C., respectively. Then, the properties such as pH value and content of FAC are checked. As shown in Table 5, the stability of the hypochlorous acid fluid is better than hypochlorous acid gel. Also, it is demonstrated that the hypochlorous acid gel prepared from phosphoric acid does not have the property that its viscosity can be changed by exerting different pressures.

TABLE 5
Ageing test for the hypochlorous acid fluid prepared from a strong
acid and the hypochlorous acid gel prepared from phosphoric acid and their properties

| | Content of | | | | | | |
|---|---|---|---|---|---|---|---|
| | FAC (ppm) | | Preservation | pH | | Before | After |
| Sample | 0 | 14 days | of FAC (%) | 0 | 14 days | pressurizing | pressurizing |
| Hypochlorous acid fluid | 170 | 117 | 68.8% | 5.72 | 6.6 | No adhesion to | Adhesion to |
| | | | | | | arms | arms |
| Hypochlorous acid gel | 177 | 102 | 57.6% | 6.49 | 6.69 | Adhesion to | Adhesion to |
| | | | | | | arms | arms |

### Embodiment 10: Comparisons of Stability for Hypochlorous Acid Fluids Prepared with Sodium Magnesium Fluorosilicates Having Specific

Ingredient Proportions Hypochlorous acid fluids are prepared with sodium magnesium fluorosilicates having specific ingredient proportions, respectively; the hypochlorous acid fluids are carried in glass bottles sealed by PP caps for a 14-day thermal ageing test at 54° C., respectively. Then, the properties such as pH value, content of FAC and adhesion of hypochlorous acid fluids sprayed are compared and shown in Table 6. According to test results such as stability, comprehensive stability, pH value, and adhesion of hypochlorous acid fluids sprayed, the sodium magnesium fluorosilicate with the concentration of 2.50 wt % performs better than another sodium magnesium fluorosilicate.

TABLE 6
Thermal ageing test for sodium magnesium fluorosilicates with
specific ingredient proportions in prepared hypochlorous acid fluids

| | Content of | | | | | |
|---|---|---|---|---|---|---|
| Sample | FAC (ppm) | | Preservation | pH | | Adhesion (After |
| Sodium magnesium fluorosilicate | 0 | 14 days | of FAC (%) | 0 | 14 days | spraying) |
| 2.50 wt % | 241 | 163 | 67.60 | 6.27 | 6.43 | Adhesion on |
| | | | | | | arms |
| 3.00 wt % | 241 | 155 | 64.50 | 6.41 | 6.58 | Adhesion on |
| | | | | | | arms |

### Embodiment 11: Test for Ageing Stability of Hypochlorous Acid Fluid

Hypochlorous acid fluid is sealed in a PET (polyethylene terephthalate) bottle on which a nozzle is installed for a 14-day thermal ageing test at 54° C. Then, the properties such as pH value and content of FAC are checked and shown in Table 7. According to test results, it can be estimated that the ageing-related parameters, such as stability of hypochlorous acid and pH value, of prepared hypochlorous acid fluid which had been stored for one year at room temperature are satisfactory.

TABLE 7
Thermal ageing test of hypochlorous acid fluid

| | Content of FAC | | | | |
|---|---|---|---|---|---|
| | (ppm) | | Preservation | pH | |
| Sample | 0 | 14 days | of FAC (%) | 0 | 14 days |
| Hypochlorous acid | 241 | 137.27 | 56.50 | 6.27 | 6.4 |
| fluid | | | | | |

### Embodiment 12: Stability of High-Concentration Hypochlorous Acid Fluids in a Thermal Ageing Test

As shown in test results in Table 8, stability of high-concentration hypochlorous acid fluids prepared herein is satisfactory.

TABLE 8
High-concentration hypochlorous acid
fluids in a thermal ageing test

| | Content of FAC | | | | |
|---|---|---|---|---|---|
| | (ppm) | | Preservation | pH | |
| Sample | 0 | 14 days | of FAC (%) | 0 | 14 days |
| High-concentration | 400 | 202 | 50.5% | 6.35 | 6.63 |
| Medium-concentration | 330 | 197 | 59.6% | 6.45 | 6.50 |
| Low-concentration | 265 | 170.7 | 64.4% | 6.41 | 6.58 |

### Embodiment 13: Comparisons Between Hypochlorous Acid Fluids Prepared with Different Strong Acids

The hypochlorous acid fluids prepared with sulfuric acids as acid agents are carried in a glass bottle sealed by a PP cap for a 14-day thermal ageing test at 54° C. after which the properties such as pH value, content of FAC and adhesion are checked.

As shown in Table 9, hypochlorous acid fluids prepared with sulfuric acids as acid agents have analogous properties such as quality, pH value and comparability of hypochlorous acid, all of which are comparable to properties of fluids prepared with hydrochloric acids in the past.

TABLE 9
Ageing test for the hypochlorous acid fluid prepared from different

| | Content of FAC (ppm) | | Residual | pH | | | |
|---|---|---|---|---|---|---|---|
| | 0 | After 14 days | content | 0 | After 14 days | | |
| | | at 54° C. | (%) | | at 54° C. | Before spraying | After spraying |
| Preparation | 258 | 182 | 70.4% | 6.27 | 6.40 | No adhesion | Adhesion |
| based on H₂SO₄ | | | | | | to arms | to arms |
| Preparation | 265 | 179 | 67.6% | 6.27 | 6.43 | No adhesion | Adhesion |
| based on HCl | | | | | | to arms | to arms |

The foregoing descriptions describe a hypochlorous acid composition according to the present invention and the test results of applications thereof. The present invention discloses a hypochlorous acid composition and applications thereof, characterized in that the viscosity of the hypochlorous acid composition can be changed by exerting different pressures, wherein a low-viscosity fluid can be transformed into a variety of fluids with different high viscosities through pressure, and in that the high-viscosity hypochlorous acid fluid can also be formed by spraying, so that the high-viscosity hypochlorous acid fluid can be evenly coated on the surface of an object without a medium. The risks of infection and contamination when using the hypochlorous acid fluid can be mitigated, while spreading the application of hypochlorous acid in sterilization as well as cleaning and washing.

The above detailed descriptions are preferable embodiments of a hypochlorous acid composition only that should not restrict the scope of the present application in practice; any modification or equivalent replacement without departing from the spirit and scope of the present application should be incorporated in claims hereinafter.

What is claimed is:

1. A hypochlorous acid composition, comprising:
a fluorosilicate with a concentration ranging from 2.00 to 4.00 wt %;
a free available chlorine (FAC) with a concentration ranging from 10 to 500 ppm;
wherein the free available chlorine (FAC) comprises hypochlorous acid and hypochlorite;
wherein a viscosity change of the hypochlorous acid composition after a pressure is applied;
wherein the viscosity change is a positive correlation with the pressure is applied.

2. The hypochlorous acid composition as claimed in claim 1 wherein the hypochlorous acid composition has a viscosity ranging from 1 to 2000 cp.

3. The hypochlorous acid composition as claimed in claim 1 wherein the hypochlorous acid composition features a viscosity ranging from 6000 to 20000 cp after the pressure is applied.

4. The hypochlorous acid composition as claimed in claim 1 wherein the hypochlorous acid composition has a pH value ranging from 5.0 to 8.0.

5. The hypochlorous acid composition as claimed in claim 1 wherein the hypochlorous acid composition has a pH value ranging from 6.0 to 7.0.

6. The hypochlorous acid composition as claimed in claim 1 wherein the fluorosilicate is sodium magnesium fluorosilicate or sodium magnesium lithium fluorosilicate.

7. The hypochlorous acid composition as claimed in claim 1, wherein the hypochlorous acid composition is manufactured by the fluorosilicate, the free available chlorine and an acid.

8. The hypochlorous acid composition as claimed in claim 7, wherein the acid is strong acid.

9. The hypochlorous acid composition as claimed in claim 7, wherein the acid is not phosphoric acid or hypochlorous acid.

10. The hypochlorous acid composition as claimed in claim 8, wherein the strong acid is Chloric acid, Hydrobromic acid, hydrochloric acid, Hydroiodic acid, nitric acid, Perchloric acid or sulfuric acid.

11. The hypochlorous acid composition as claimed in claim 1 wherein the hypochlorous acid composition further include chlorate, bromide, chloride, iodide, nitrate, perchlorate, or sulfate.
